(19) United States
(12) Patent Application Publication
(10) Pub. No.: US 2022/0053748 A1
(43) Pub. Date: Feb. 24, 2022

(54) CHUM SLICING BLOCK AND METHOD

(71) Applicant: Andre Incorvaia, Howell, NJ (US)

(72) Inventor: Andre Incorvaia, Howell, NJ (US)

(21) Appl. No.: 16/996,187

(22) Filed: Aug. 18, 2020

(51) Int. Cl. A01K 97/04; A22C 25/18; A22C 25/08

(52) U.S. Cl. CPC A01K 97/045; A22C 25/08; A22C 25/185

(57) ABSTRACT

The present invention comprises a rectangular block, having a front face, a rear face, and two side faces. The front and rear faces have multiple pairs of aligned vertical slots, into which a knife can be inserted and moved up and down in a vertical cutting motion. The block is open at the top and openable at the bottom by means of a sliding or hinged trap door. In use, uncut chum is loaded into the block through the top opening, and the sliced chum accumulates within the block until the bottom door is opened, thereby depositing the sliced chum in a container beneath the block. The container serves to collect the chum and store it until it is used.

### FIELD OF INVENTION

The present invention relates to the general field of slicing and chopping blocks, and more particularly to slotted slicing/chopping blocks.

### BACKGROUND OF THE INVENTION

In order to attract fish to a fishing boat, “chum”—consisting of pieces of bait and fish carcasses—is frequently spread in the water around the boat. The task of slicing the chum is an unpleasant and laborious one if done piece-by-piece. Existing chopping blocks designed for bread and meat are ill-suited to this task, because they lack a means for effectively collecting and storing the chum after it has been sliced.

### SUMMARY OF THE INVENTION

The present invention comprises a rectangular block, having a front face, a rear face, and two side faces. The front and rear faces have multiple aligned vertical slots, into which a knife can be inserted and moved up and down in a vertical cutting motion. The block is open at the top and openable at the bottom by means of a sliding or hinged trap door. In use, uncut chum is loaded into the block through the top opening, and the sliced chum accumulates within the block until the bottom door is opened, thereby depositing the sliced chum in a container beneath the block. The container serves to collect the chum and store it until it is used.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a front perspective view of one embodiment of the present invention;

FIG. 2 is a side perspective view of one embodiment of the present invention;

FIG. 3 is a top perspective view of one embodiment of the present invention, with the bottom sliding door closed; and

FIG. 4 is a top perspective view of one embodiment of the present invention, with the bottom sliding door opened.

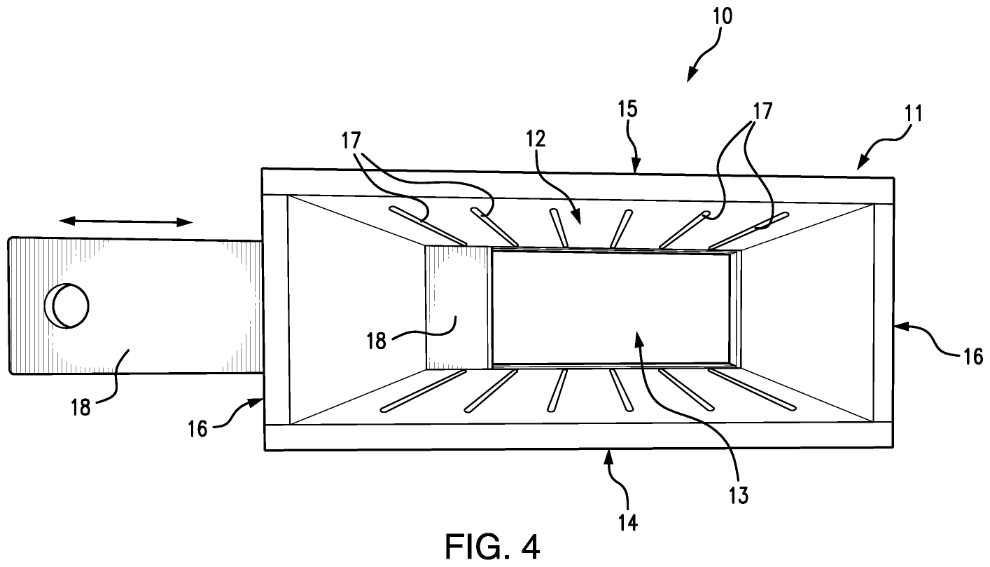

### DETAILED DESCRIPTION OF THE PREFERRED EMBODIMENT

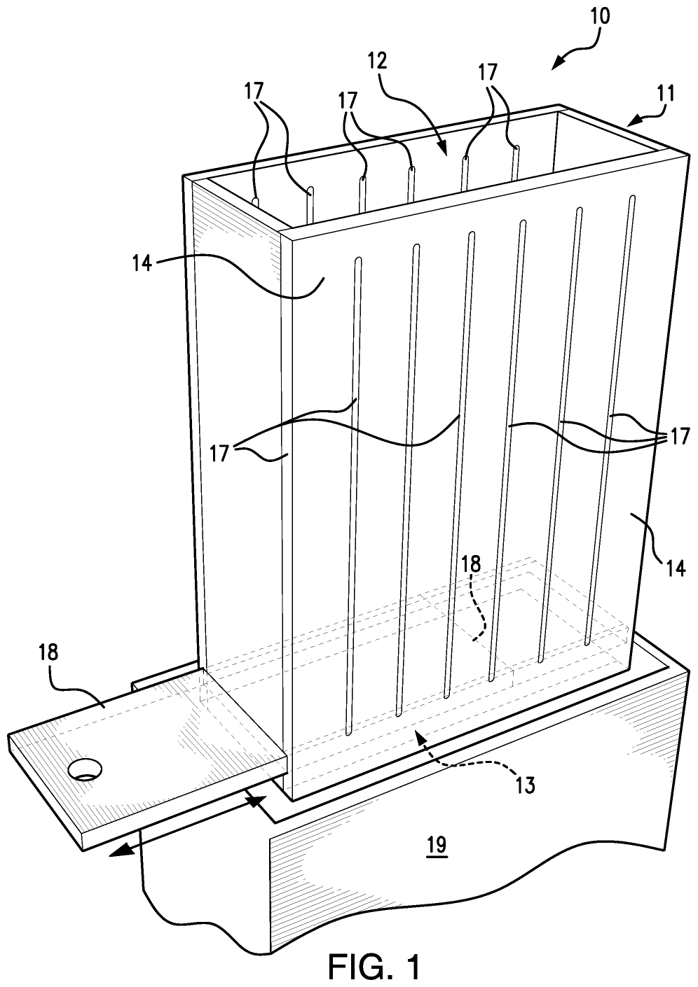

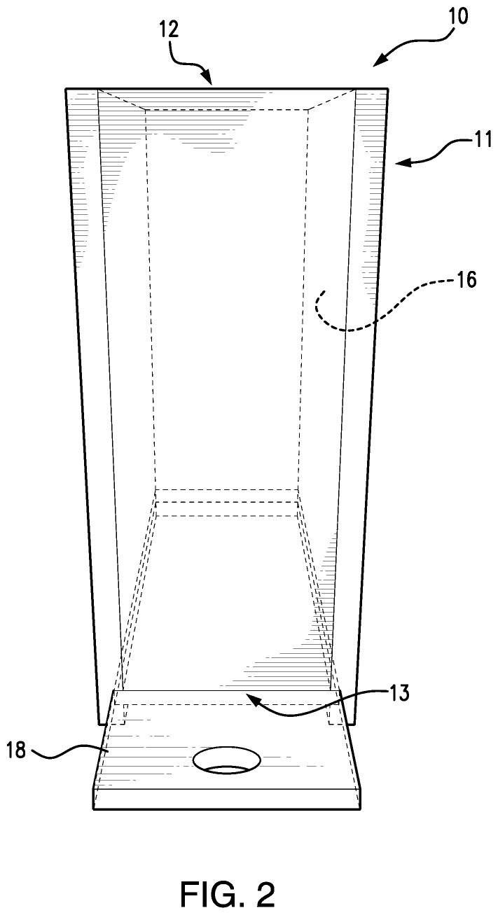

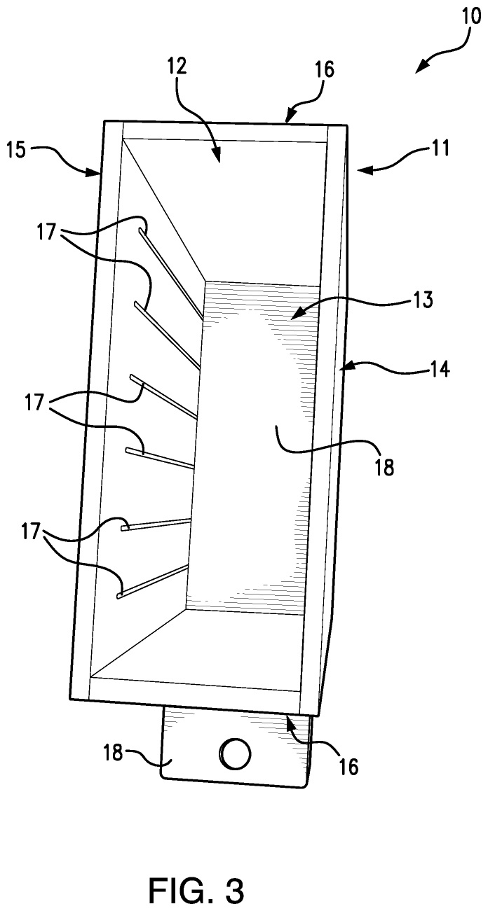

Referring to FIGS. 1-3, one embodiment of the present invention 10 comprises a rectangular slicing block 11, having a top opening 12, a bottom opening 13, a front face 14, a rear face 15, and two side faces 16. The front face 14 and the rear face 16 have multiple aligned vertical blade slots 17, into which a knife blade can be inserted and moved vertically upward and downward. The bottom opening 13 is covered by a trap door 18, which can be a sliding door, as shown in the figures, or a downward-opening hinged door (not shown). Beneath the bottom opening 13 is a chum container 19, such that, when the trap door 18 is opened, contents of the slicing block fall into the container 19.

The method of use of the present invention is to load unsliced chum into the slicing block 11 through the top opening 12, then insert the knife blade through one or more pairs of aligned blade slots 17 and move the blade up and down in a slicing motion. After the chum has been sliced, the trap door 18 is opened, and the sliced chum falls through the bottom opening into the chum container 19, where the sliced chum is collected and stored until it is used.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. An apparatus for slicing chum with a knife blade, comprising:
a rectangular slicing block, having a top opening, a bottom opening, a front face, a rear face, and two side faces, wherein the front face and the rear face have multiple pairs of aligned vertical blade slots, configured to enable vertical movements of the knife blade within the blade slots, and wherein the bottom opening is covered by a trap door;
a chum container located below the trap door, such that, when the trap door is opened, contents of the slicing block fall into the chum container.

2. The apparatus according to claim 1, wherein the trap door is a sliding door or a hinged door that opens downward.

3. A method for slicing chum with a knife blade, using the apparatus according to claim 1, comprising the following steps:
(a) providing the apparatus according to claim 1;
(b) loading unsliced chum into the slicing block through the top opening;
(c) inserting the knife blade through one or more of the pairs of aligned vertical blade slots;
(d) moving the knife blade vertically upward and downward so as to slice the unsliced chum and produce sliced chum;
(e) opening the trap door so as to allow the sliced chum to fall through the bottom opening into the chum container; and
(f) collecting and storing the sliced chum in the chum container until the sliced chum is used.

4. The method according to claim 3, comprising the following additional step between steps (e) and (f):
(e1) repeating steps (b) through (e) until the sliced chum fills the chum container;

5. A method for slicing chum with a knife blade, using the apparatus according to claim 2, comprising the following steps:
(a) providing the apparatus according to claim 2;
(b) loading unsliced chum into the slicing block through the top opening;
(c) inserting the knife blade through one or more of the pairs of aligned vertical blade slots;
(d) moving the knife blade vertically upward and downward so as to slice the unsliced chum and produce sliced chum;
(e) opening the trap door so as to allow the sliced chum to fall through the bottom opening into the chum container; and
(f) collecting and storing the sliced chum in the chum container until the sliced chum is used.

6. The method according to claim 5, comprising the following additional step between steps (e) and (f):
(e1) repeating steps (b) through (e) until the sliced chum fills the chum container.
